(19) United States
(12) Patent Application Publication
(10) Pub. No.: US 2012/0284361 A1
(43) Pub. Date: Nov. 8, 2012

(54) Determination of the transmission capacity in data networks

(75) Inventor: Jens Henschel, Willingshausen (DE)

(73) Assignee: Vodafone Holding GmbH, Dusseldorf (DE)

(21) Appl. No.: 13/464,730

(22) Filed: May 4, 2012

(30) Foreign Application Priority Data
May 6, 2011 (DE) 10 2011 100 793.1

(51) Int. Cl. G06F 15/16

(52) U.S. Cl. 709/217

(57) ABSTRACT

A system, method, and apparatus are provided for determining transmission capacity in bidirectional data lines in a data network. A network node is connected to a second network node via the bidirectional data lines. A computer-based measuring program is installed on the node, whereby the program is configured to download a first reference file having a first reference size from the second node, starting at a first point in time, and ending at a second point in time. The program is also configured to upload a second reference file having a second reference size to the second network node between the first and second points in time simultaneously with downloading the first reference file. Further, the program determines the data rate available for the downloading, based on the time interval between the first and second points in time, and the reference size of the first reference file.

### CROSS-REFERENCE TO RELATED APPLICATION

This application claims priority to German (DE) Patent Application No. 10 2011 100 793.1, filed on May 6, 2011, the contents of which are incorporated by reference as if set forth in their entirety herein.

### BACKGROUND

The Internet makes many applications available to users for: listening to music, watching videos, opening and displaying websites, and buying and selling online, for example. Each of these applications uses the Internet connections in different ways, and the required capacity of the Internet connection, such as the bandwidth, made available for the transmission of data depends on the application requirements and on the user wishes.

In order to be able to compare the momentary data transmission rate (or data rate) of an Internet connection with the specifications provided by the operator and, if applicable, in order to be able to ascertain or analyze data transmission problems, so-called speed testers (or Internet bandwidth speed testers) are commercially available as measuring instruments. The data rate (data volume per unit of time) to be measured is also often referred to as the bandwidth of the Internet connection. Some of these speed testers are external devices that can be connected to a computer system, for example, to a personal computer (PC) which is connected to the Internet by a suitable data connection and on which an appropriate measuring program (testing software) is running. On the other hand, the speed testers can also be configured as testing software that is loaded via a suitable medium (for example, from a CD or from a USB stick) onto the computer that is connected to the Internet and that can then be executed from there. As an alternative to data carriers, such testing software can also be loaded from the Internet onto the computer in question in order to be executed.

The article by J. Jongerius titled “Broadband Speed Tester Benchmarks”, http://www.myspeed.com/whitepapers/benchmarks.html, Visualware, May 4, 2005 reveals that different speed testers yield very different and, at times, non-reproducible results for the actually available data rate (bandwidth) of the Internet broadband connection that is configured as a cable modem with a known download speed of 4.23 Mbps for downloading data from a data source, and with a known upload speed of 370 kbps for uploading data to a data recipient. Reasons for the varying results of the data rate measurement can be, for example, the precision of the time measurement pertaining to the starting and ending times of the download/upload as well as whether an under-utilization of the maximum data rates available at the beginning of the upload/download was taken into consideration or not.

However, even when the above-mentioned effects are taken into consideration, the speed testers available on the market (or Internet bandwidth speed testers) do not yield realistic results since these speed testers do not take into account the effects that parallel data traffic in the opposite direction has on the data rate in bidirectional data connections.

### SUMMARY

One embodiment relates to a network node for determining the transmission capacity in bidirectional data lines in a data network as well as to a corresponding system and method.

Here, the term “network node” refers to a device that is connected to a data network, for example, a computer network, a client-server network, or the Internet, or that is part of this data network. In this context, network nodes are points where different parts of a data network or different data networks are connected. Therefore, the communication between the connected parts of the data network(s) takes place via network nodes. A network node, especially the first and second network nodes, can be configured, for instance, as a router, a server or an integrated access device (IAD). Network nodes can be addressable and can be administered by a network management system. The network node according to one embodiment also comprises software, among other things, the computer-based measuring program. The computer-based measuring program is, for example, a Linux-based program. The computer-based measuring program can be based on Ubuntu Linux, which allows a simple use of Linux. With Ubuntu, an operating system that is simple to install and easy to operate can be created with coordinated software. Here, precisely one program is provided for each task. The computer-based measuring program can be installed, for example, online, on the network nodes. As an alternative, it can be loaded, for example, via external data carriers such as, for instance, a USB stick, onto devices such as the network nodes. In addition to determining the transmission capacity, the computer-based measuring program can also measure and evaluate additional quantities that are relevant for the data transmission. Such quantities are, for example, the ping time, the DNS query time, the RTP jitter and the packet loss of passive and active VoIP connections, as well as the web server capacity. The results obtained with the computer-based measuring program can be transferred to appropriately selected places in the data network after the determination.

In this context, data networks are systems with which data connections are established between devices, for example, network nodes. Data networks are, for example, local area networks (LAN) or wide area networks (WAN) such as the Internet. Depending on the supply structure, a distinction is made between front-end backbone networks and back-end networks that connect terminal devices, or front-end networks or back-end systems such as, for instance, a server and a host, among each other as well as to other networks or systems. The data connections in the data network can be implemented via data cables or via wireless data connections.

The term transmission capacity as set forth here refers to the data volume that can be transmitted per unit of time via a data connection (data line) from one network node to another network node. A bidirectional data connection allows data transmission in both directions of the data connection, that is to say, for example, from a first network node to a second network node as well as from the second network node to the first network node.

The term downloading refers to the transmission of data from the outside (for example, from the second network node) to the network node. Downloading is the opposite of uploading, which refers to data transmission (data flow) in the opposite direction, that is to say, from the network node to the outside (for example, to the second network node). In one embodiment, the downloading is carried out according to the HTTP and/or the uploading is carried out according to the FTP. HTTP is the protocol for transmitting data via a network such as the World Wide Web. The FTP (File Transfer Protocol) is a specified network protocol for transmitting files via IP networks. FTP uses separate connections for the control and for the data transmission.

The term “reference file” refers to a file that comprises a precisely determined volume of data (file size). In one embodiment, this precisely determined file size is referred to as the reference size. Precise knowledge of the reference size of the reference files, especially the first to fourth reference sizes of the first to fourth reference files, is a fundamental prerequisite for determining the transmission capacity since the starting point and the end point of the data transmission for the reference files as well as the time interval for the data transmission of the reference files are determined on the basis of the measured signal and, using the known reference sizes, this time interval is converted into a data transmission rate as the actually available data rate.

Network nodes according to one embodiment provide the transmission capacity of bidirectional data connections in data networks that can be reliably determined. In particular, in contrast to speed testers already available on the market, the determination of the transmission capacity according to one embodiment yields realistic results because the effects that opposite parallel data traffic in bidirectional data connections might have on the data rate are taken into account. Here, the second reference file constitutes an interference in the uploading operation whose uploading—depending on the bandwidth of the data connection—can have a negative effect on the data rate available for downloading a file. On the basis of the theoretically available bandwidth of the data connection and of the known size of the first reference file, a certain data rate could theoretically be expected. However, it has been found that the data rate actually available for downloading is less than the theoretically expected data rate if, in parallel to the downloading, a second file is being uploaded to a second network node via this data connection. In order for these results to be reliable, the file that is to be uploaded as a second reference file likewise has a specific second reference size, so that the interference with the process of downloading the first reference file is specific, comparable and reproducible. This technique for determining the transmission capacity via the bidirectional data connection constitutes an active capacity measurement, since here, in contrast to the devices available on the market for measuring the data transmission capacity, bidirectional data traffic is actively started. Since this active data traffic is defined by the known reference sizes of the transmitted reference files, the exact data transmission capacity for a realistic operation of the data connection or of several data connections in the data network can be determined. With this realistic measurement of the transmission capacity of a data connection between two network nodes, it is possible to locate the cause of the error (or the problem) for a slow data transmission in the data network that has been noticed by the final customer. For example, it can be ascertained whether the slow data transmission to the final customer is because the transmission capacity in the data network is too small or whether this is perhaps caused by a problem on the computer of the final customer. For example, a virus on the customer's computer can cause data transmission to be slow, which is often erroneously blamed on the network operators. By performing the determination of the transmission capacity in the data network, for example, it can be pointed out to the final customer that the transmission problem can only be solved locally on his or her computer. Moreover, the determination of the transmission capacity according to one embodiment makes it possible to monitor the properties of the data network and, if necessary, to improve them. on the one hand, the determination of the transmission capacity can be started actively by an action or indirectly as a result of an action or, on the other hand, it can be started automatically after a certain period of time has lapsed.

Here, a first reference size of 10 MB or more is advantageous in order to precisely determine the available data rate. In one embodiment, the first reference size is more than 30 MB, preferably more than 50 MB, especially preferably 100 MB.

In another embodiment, the computer-based measuring program is configured in such a way that it is additionally provided for uploading at least a third reference file having a third reference size to the second network node at a third point in time as the starting point of the downloading, and at a fourth point in time as the end point of the uploading, and it is provided for downloading at least a fourth reference file having a fourth reference size from the second network node between the third and fourth points in time simultaneously to the uploading of the third reference file, and it is at least provided to determine the data rate available for the uploading on the basis of the time interval between the third and fourth points in time, and on the basis of the reference size of the third reference file. In this manner, in addition to determining the realistic data rate for the downloading, the data rate realistically available for uploading a file is also determined, so that a user obtains realistic data about the data rate available for both transmission directions. Hence, the quality of the data connection between the two network nodes is determined for both directions.

Here, a third reference size of 1 MB or more is advantageous for a precise determination of the available data rate. In one embodiment, the third reference size is more than 1 MB, preferably more than 2 MB, especially preferably 3 MB.

The first to fourth reference files can be stored on all of the network nodes in the data network for use by the computer-based measuring program, or else they can be stored together with the computer-based measuring program on the network node on which the computer-based measuring program has been installed. In this case, the appropriate reference files that are to be downloaded are transmitted to the second network node before the start of the determination of the transmission capacity, in order to subsequently be downloaded from there to the first network node during the execution of the computer-based measuring program.

In another embodiment, the computer-based measuring program is configured in such a way that the computer-based measuring program is started and executed in the background in response to an interaction on the part of the user with the terminal device that is connected to the network node for purposes of dynamically determining the data rate available between the first and second network nodes. By coupling the determination of the transmission capacity to an action by the user, it is ensured that this determination takes place for a specific state or point in time while the user is employing the data network. Consequently, the determined values are realistic for the way in which the user employs the data network. Here, the term “terminal device” refers to a device in the environment of the user that is connected to the network node, for example, a home computer or a mobile terminal device of the user.

In one embodiment, the computer-based measuring program is configured in such a way that the transmission capacity is determined during data traffic that is additionally taking place on the bidirectional data connection. Data traffic is defined here as unidirectional or bidirectional data transmission along a data connection. This data traffic can be initiated, for example, by the network node specifically for this determination (active data traffic), or else initiated by the user, or it can be data traffic that just happens to be taking place via this data connection for other reasons (passive data traffic). In the case of active data traffic, for example, a simulated telephone conversation can be initiated by the network node for measuring purposes. As an alternative, the bidirectional data connection can be used specifically by users as a VoIP connection (e.g., a telephone conversation as passive data traffic or as a passive VoIP connection), while in the background of this utilization, the data rate that is truly available via this connection is determined by the computer-based measuring program during the ongoing VoIP connection. To execute the computer-based measuring program for the determination, during data traffic not initiated by the network node the network node may invoke the computer-based measuring program when such data traffic is ascertained. Additionally, the measuring program may periodically check for the presence of data traffic via the network node. If data traffic is present, the program initiates determination of the available data rate. A suitable starting mode is selected for the computer-based measuring program.

Moreover, one embodiment relates to a system for determining the transmission capacity in a data network, comprising at least a first and a second network node that are connected to each other via bidirectional data connections, whereby at least the first network node is a network node according to one embodiment, having a computer-based measuring program installed on it that allows a dynamic determination of the data rate available in the bidirectional data connection to the second network node. In another embodiment, the second network node is also a network node according to one embodiment, having a computer-based measuring program installed on it that allows a dynamic determination of the data rate available in the bidirectional data connection to the first network node and/or to another network node.

In one embodiment of the system, at least the first network node adapts the configuration of the first and/or second network node in response to the data rate determined with the computer-based measuring program for the bidirectional data connection in such a way that the available data rate is increased, preferably the adaptation of the configuration consists of a suitable prioritization of the data that is to be transmitted. For example, the computer-based measuring program can carry out a prioritization of the data transmission if there are several files that are to be transmitted, so that the files that are needed quickly are transmitted with priority preferably via the measured data connection, while the other files that are not needed as quickly are only transmitted later, when sufficient bandwidth is once again available. In this manner, the volume of data to be transmitted can be adapted to the actually available data rate. As an alternative to this, data could be diverted to the intended network node via another network node using a switch actuated by the computer-based measuring program.

In another embodiment, the system automatically starts the computer-based measuring program without interaction on the part of the user with one of the network nodes that are suitable for a continuous determination of the data rate available in the bidirectional data connection. A periodical determination of the transmission capacity of a data connection offers a realistic picture of the data rate available over a desired period of time. On the basis of this picture, for example, a necessary improvement of the data network in certain areas can be recognized and accordingly implemented, which increases customer satisfaction. In one embodiment of the system, the second network node is also a network node according to one embodiment.

A method is also provided for determining the transmission capacity in data networks between a first network node, which is a network node according to one embodiment, and a second network node connected to it via a bidirectional data connection, making use of a computer-based measuring program installed on the first network node for purposes of dynamically determining the data rate available in the bidirectional data connection, by executing the following steps:
downloading at least a first reference file having a first reference size from the second network node to the first network node at a first point in time as the starting point of the downloading and at a second point in time as the end point of the download,
uploading at least a second reference file having a second reference size from the first network node to the second network node between the first and the second points in time simultaneously with the downloading of the first reference file, and
determining the data rate available for the downloading on the basis of the time interval between the first and second points in time and on the basis of the reference size of the first reference file.

In one embodiment of the method, the computer-based measuring program additionally executes the following steps:
uploading at least a third reference file having a third reference size from the first network node to the second network node at a third point in time as the starting point of the downloading and at a fourth point in time as the end point of the upload,
downloading at least a fourth reference file having a fourth reference size from the second network node to the first network node between the third and the fourth points in time simultaneously with the uploading of the third reference file, and
determining the data rate available for the uploading on the basis of the time interval between the third and fourth points in time and on the basis of the reference size of the third reference file.

In another embodiment of the method, the data rates available for the downloading and the uploading are determined at the same time, here, the first reference file preferably corresponds to the fourth reference file and/or the second reference file preferably corresponds to the third reference file. Due to the simultaneous determination, realistic results are obtained for the normal operation of a data network, since simultaneous uploading and downloading of files is typical during the normal operation of the data networks. In this process, the two-fold use of the first and second reference files for determining the reverse transmission capacity saves memory space on the network nodes.

In another embodiment, the method also comprises the step of adapting a configuration of the first and/or second network node in response to the data rate determined with the computer-based measuring program, so that the available data rate is increased, preferably, the step of adapting the configuration consists of a suitable prioritization of the data that is to be transmitted.

In another embodiment, the method also comprises the step of starting additional data traffic that is taking place via the network node (active data traffic) for purposes the parallel determination of the transmission capacity on the bidirectional data connection, or it comprises determining data traffic that is taking place on the bidirectional data connection (passive data traffic) via the network node, which initiates the starting of the computer-based measuring program for the parallel determination of the transmission capacity on the bidirectional data connection. Consequently, the actually present data rate can be tested even more realistically and appropriate steps for improving the data connection can be carried out on the basis of the measured results obtained.

In another embodiment, the method also comprises one or more steps for measuring one or more elements from the group including the ping time, the DNS query time, the RTP jitter and the packet loss of passive and active VoIP connections, as well as the web server capacity. These elements can be determined with active or passive data traffic or without additional data traffic.

### BRIEF DESCRIPTION OF THE DRAWINGS

These and other aspects of embodiments are shown in detail in the figures as follows:

FIG. 1 is a block diagram of a system with network nodes according to embodiments of the claimed subject matter; and

FIG. 2 is block diagram of the method according to embodiments of the claimed subject matter.

### DETAILED DESCRIPTION OF SPECIFIC EMBODIMENTS

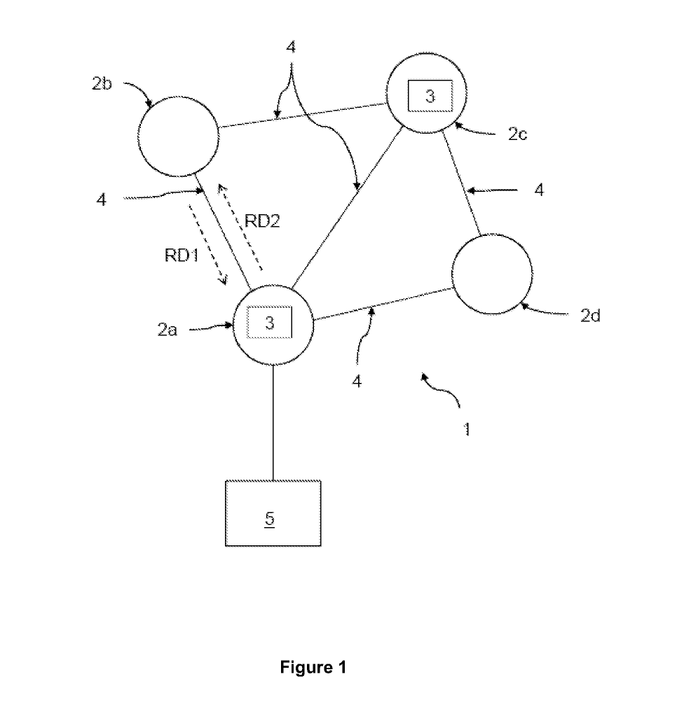

FIG. 1 shows an embodiment of a system with network nodes 2a-2d according to one embodiment. The system comprises a first, a second, a third and a fourth network node 2a-2d that are connected among each other by the bidirectional data connections 4. On the network nodes 2a and 2c, computer-based measuring programs 3 are installed which can perform a dynamic determination of the data rates available in the bidirectional data connections 4 between the network nodes 2a-2d. By way of an example, the installed computer-based measuring program 3 determines the data rate available for downloading a file from the network node 2b to the network node 2a for the transmitted reference files RD1 and RD2, as indicated by the broken arrow. The computer-based measuring program 3 on the first network node 2a determines the data rate available for downloading in that the first reference file RD1 is downloaded during an upload of the second reference file that is taking place simultaneously from the network node 2a to the second network node 2b. An analogous measurement can be carried out with the computer-based measuring program 3 for the data connections 4 to the network nodes 2c and 2d. Due to the additional computer-based measuring program 3 installed in the system on the network node 2c, the available data rates can be determined for the data connections 4 between the network nodes 2b and 2c as well as 2c and 2d. In the depicted system according to one embodiment, a terminal device 5 of a user of the data network 1 is connected to the network node 2a. Here, the installation of the computer-based measuring program 3 on the network node 2a is also configured in such a way that the computer-based measuring program 3 is started and executed in the background in response to an interaction on the part of a user with the terminal device 5 for the dynamic determination of the data rate available between the first and second network nodes 2a, 2b. Moreover, the computer-based measuring program 3 is configured in such a way that it can analogously also determine the data rate available for the uploading in that it uploads a third reference file having a third reference size to the second network node 2b while simultaneously downloading a fourth reference file from the second network node 2b.

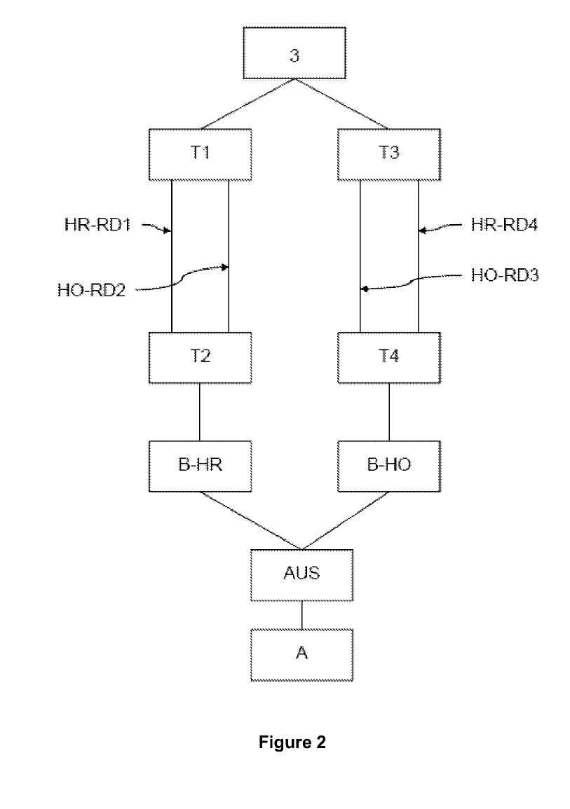

FIG. 2 is a block diagram of the method according to the claimed subject matter. The method determines the transmission capacity in a data connection 4 between a first network node 2a according to one embodiment on which a computer-based measuring program 3 is installed, and a second network node 2b. The computer-based measuring program 3 is used here for a dynamic determination of the data rates B-HR, B-HO available in the bidirectional data connection 4. For this purpose, the method comprises the steps summarized herein.

After the computer-based measuring program 3 has been started on the first network node 2a, a first reference file RD1 having a first reference size is downloaded from the second network node 2b to the first network node 2a. The process of downloading starts at a first point in time T1 and ends after a complete downloading at a second point in time T2. Parallel to this, a second reference file RD2 having a second reference size is uploaded from the first network node 2a to the second network node 2b between the first and second points in time T1, T2. After the downloading has been completed, the data rate B-HR available for the downloading is determined on the basis of the time interval between the first and second points in time T1, T2 and on the basis of the reference size of the first reference file RD1. For the determination B-HR, the first reference size is divided by the time period between T1 and T2. Correspondingly, the available data rate B-HO can likewise be determined for uploading files in the data connection 4 between the first and second network nodes 2a and 2b. For this purpose, a third reference file RD3 having a third reference size is uploaded from the first network node 2a to the second network node 2b. The uploading H0-RD3 starts at a third point in time T3 and is completed at a fourth point in time T4. Parallel to this, a fourth reference file RD4 having a fourth reference size is downloaded HR-RD4 from the second network node 2b to the first network node 2a between the third and fourth points in time T3, T4. After the uploading has been completed, the data rate B-HO available for the uploading is determined on the basis of the time interval between the third and fourth points in time T3, T4 and on the basis of the reference size of the third reference file RD3. For the determination B-HO, the third reference size is divided by the time period between T3 and T4. The results for B-HR and B-HO can be subsequently evaluated. This evaluation AUS can be carried out by the computer-based measuring program 3 itself. In another embodiment, the computer-based measuring program 3 is configured in such a way that it transmits the ascertained available data rates to the appropriate data connections 4 at a central site. This central site is, for example, connected to the data network 1, to which the data connection 4 belongs, for which the available data rates were determined. If additional measurements were carried out for the ping time, the DNS query time, the RTP jitter and the packet loss of passive and active VoIP connections, as well as the web server capacity, these measurements can also be included in the evaluation AUS. The ping time (also called the RTT) refers to the round-trip time of a data packet, that is to say, the time from sending a file to an address until an acknowledgment is received after this file has been received at this address. DNS is a worldwide hierarchical distributed naming system that manages the namespace of the Internet. For the most part, the DNS is used to convert domain names into IP addresses. RTP refers to a transport protocol for speech connections in VoIP connections. IP telephony (Internet protocol telephony) refers to telephoning via computer networks that are set up according to Internet standards. In this process, typical information for telephony, that is to say, speech and control information, for example, for establishing the connection, is transmitted via a network that can also all be used for data transmission. When it comes to the subscribers, it is the case that computers, telephone terminal devices specialized in IP telephony as well as classic telephones connected by special adapters can all be used to establish the connection. In one embodiment, the network node according to one embodiment can use a VoIP connection that runs passively via the bidirectional data connection in order to ascertain the data rate available on this bidirectional data connection, or else it can actively establish a VoIP connection with data traffic via this bidirectional data connection, whereby the available data rate is determined in parallel to this.

This evaluation AUS can be used to adapt the configuration of the first and/or second network node 2a, 2b by the network nodes 2a, 2b for the bidirectional data connection 4 in such a way that the available data rates B-HR, B-HO are increased. For example, the adaptation A of the configuration consists of a suitable prioritization in the appertaining network nodes 2a, 2b of the data that is to be transmitted.

The embodiments shown here are only examples and are not intended to be construed in a limiting manner. Alternative embodiments are likewise encompassed by the protective scope of the claimed subject matter.

What is claimed is:

1. A network node, comprising:
one of a server or a router, for a data network comprising several network nodes, comprising:
a computer-based measuring program installed on the network node and configured to:
dynamically determine a transmission capacity in the data network of a data rate available in a bidirectional data connection to a second network node;
download at least a first reference file having a first reference size from the second network node starting at a first point in time, and ending at a second point in time;
upload at least a second reference file having a second reference size to the second network node between the first point in time and the second point in time simultaneously with downloading the first reference file; and
determine a data rate available for the downloading based on a time interval between the first point in time and the second point in time, and the reference size of the first reference file.

2. The network node of claim 1, wherein the first reference size is greater than 30 megabytes (MB), 50 MB, or 100 MB.

3. The network node of claim 2, wherein the computer-based measuring program is configured to:
upload a third reference file, comprising a third reference size, to the second network node starting at a third point in time, and ending at a fourth point in time;
download a fourth reference file comprising a fourth reference size from the second network node between the third point in time and the fourth point in time simultaneously to uploading the third reference file; and
determine a data rate available for uploading based on a time interval between the third point in time and the fourth point in time, and the third reference size.

4. The network node of claim 3, wherein the third reference size is greater than 1 MB, 2 MB, or 3 MB.

5. The network node of claim 1, wherein the computer-based measuring program is configured to start and execute in a background computing environment in response to a user interaction with a terminal device connected to the network node for dynamically determining a data rate available between the network node and the second network node.

6. The network node of claim 1, wherein downloading is based on one of the hypertext transfer protocol (HTTP) or file transfer protocol (FTP).

7. The network node of claim 1, wherein the computer-based measuring program is configured to determine the transmission capacity during data traffic that is additionally taking place on the bidirectional data connection.

8. A system for determining transmission capacity in a data network, comprising:
a first network node, comprising:
one of a server or a router, for a data network comprising several network nodes; and
a computer-based measuring program installed on the network node and configured to:
dynamically determine a transmission capacity in the data network of a data rate available in a bidirectional data connection to a second network node;
download at least a first reference file having a first reference size from the second network node starting at a first point in time, and ending at a second point in time;
upload at least a second reference file having a second reference size to the second network node between the first point in time and the second point in time simultaneously with downloading the first reference file; and
determine a data rate available for the downloading based on a time interval between the first point in time and the second point in time, and the reference size of the first reference file; and
a second network node, wherein the first network node and the second network node are connected to each other via a bidirectional data connection.

9. The system of claim 8, wherein the first network node adapts a configuration of the first network node or the second network node in response to the dynamic determination such that the data rate available is increased, wherein the first network node adapts using a prioritization of data that is to be transmitted.

10. The system of claim 8, wherein the system automatically starts the computer-based measuring program without interaction between a user and one of the first network node or the second network node that is configured to continuously determine the data rate available in the bidirectional data connection.

11. A method for determining transmission capacity in a data network, comprising:
downloading a first reference file having a first reference size from a second network node to a first network node starting at a first point in time and ending at a second point in time, wherein the transmission capacity is determined between the first network node and the second network node, wherein the second network node is connected to the first network node with a bidirectional data connection, and wherein the first network node comprises:
one of a server or a router, for a data network comprising several network nodes, comprising:
a computer-based measuring program installed on the network node and configured to:
dynamically determine a transmission capacity in the data network of a data rate available in a bidirectional data connection to a second network node;
download at least a first reference file having a first reference size from the second network node starting at a first point in time, and ending at a second point in time;
upload at least a second reference file having a second reference size to the second network node between the first point in time and the second point in time simultaneously with downloading the first reference file; and
determine a data rate available for the downloading based on a time interval between the first point in time and the second point in time, and the reference size of the first reference file;
and wherein the computer-based measuring program is configured to dynamically determine the data rate available in the bidirectional data connection, by:
uploading second reference file comprising a second reference size from the first network node to the second network node between the first point in time and the second point in time simultaneously with downloading the first reference file; and
determining the data rate available for the downloading based on a time interval between the first point in time and the second point in time, and the first reference size.

12. The method of claim 11, comprising
uploading a third reference file comprising a third reference size from the first network node to the second network node starting at a third point in time and ending at a fourth point in time;
downloading a fourth reference file comprising a fourth reference size from the second network node to the first network node between the third point in time and the fourth point in time simultaneously with uploading the third reference file; and
determining the data rate available for the uploading based on a time interval between the third point in time and a fourth point in time and the third reference size.

13. The method according to claim 12, wherein the data rate available for downloading is determined at a same point in time as the data rate available for uploading is determined, and wherein the first reference file corresponds to one of: the second reference file, the third reference file, and the third reference file.

14. The method of claim 11, comprising adapting a configuration of one of: the first network node and the second network node, in response to a data rate determination by the computer-based measuring program, such that an available data rate is increased using a prioritization of data that is to be transmitted.

15. The method of claim 11, comprising starting additional data traffic that is taking place via a network node for parallel determination of the transmission capacity on the bidirectional data connection.

16. The method of claim 11, comprising determining data traffic that is taking place on the bidirectional data connection via a network node, which initiates the computer-based measuring program for parallel determination of the transmission capacity on the bidirectional data connection.
